(19) United States
(12) Patent Application Publication
(10) Pub. No.: US 2006/0201205 A1
(43) Pub. Date: Sep. 14, 2006

(54) Mold for molding optical lenses

(75) Inventor: Charles Leu, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/322,062

(22) Filed: Dec. 29, 2005

(30) Foreign Application Priority Data
Mar. 9, 2005 (CN) 200510033531.1

(51) Int. Cl. C03B 11/08; C03B 9/48

(52) U.S. Cl. 65/374.11; 65/374.12; 65/374.13

(57) ABSTRACT

The present invention relates aA mold for molding an optical lenses, the mold (1) includes a press molding part (20) having a press surface (22). A material of the press molding part is a composition of cerium partially stabilized zirconia (Ce—PSZ), yttrium partially stabilized zirconia (Y—PSZ), alumina (Al₂O₃) and one or more noble metals by a hot pressing method. The noble metals are selected from the group consisting of platinum (Pt), platinum-iridium alloy (PtIr) and rhenium-iridium alloy (ReIr). A shape of the press surface is spherical or aspheric. The mold further includes a molding base (10) adjoining the press molding part. A material of the molding base is a hard alloy, ceramics or silicon-based substrate. The mold also further includes an intermediate layer (25) sandwiched between the molding base and the press molding part. Preferably, the material of the intermediate layer is tungsten or tantalum.

### TECHNICAL FIELD

The invention relates generally to a molds for molding an optical lenses, and more particularly to a mold for molding an optical lens which has high mechanical strength and does not deform at high temperatures.

### BACKGROUND

In recent times, there has been a trend for products such as digital cameras and mobile phones with digital camera modules to be small-sized, lightweight and inexpensive. To meet this demand, a number of simplified lens systems have been developed. Since simplification of conventional spherical lenses is limited, aspheric lenses are commonly needed. However, the manufacturing of aspheric lenses using conventional polishing methods is problematic. For this reason, manufacturing aspheric lenses by a press molding method has become popular.

A mold for press molding an optical lens with high accuracy generally needs to satisfy the following requirements: (1) the mold is strong and not easily deformed, even at high temperatures; (2) the material of the mold surface does not react with glass at high temperatures (i.e., the glass does not adhere to the mold surface); (3) the press surface of the mold is hard enough to withstand damage by scratching or the like; and (4) the mold has superior resistance to heat shock.

A conventional mold for press molding an optical lens can comprise silicon carbide (SiC), silicon nitride (Si₃N₄), titanium nitride (TiN), titanium carbide (TiC), vitreous carbon, tungsten carbide (WC), or a nickel alloy. However, SiC, Si₃N₄, and TiC have very high hardness, and it is difficult to form these materials into an aspheric shape with high accuracy. In addition, SiC, Si₃N₄, TiC and WC are all sintered when the mold is formed, thus requiring the addition of a third component as a sintering agent. Typically, the third component easily reacts with glass, which makes it very difficult to use the mold to make an optical lens with high accuracy. Furthermore, press molding using a mold made of SiC, Si₃N₄, TiC and WC, vitreous carbon or TiN is problematic. This is because the press surface of the mold is prone to be oxidized and thus deteriorates, unless the concentration of O₂ is controlled to be low. For molds made from a Nnickel alloy, grain growth occurs when the mold presses a workpiece at about 500° C. This eventually leads to the press surface of the mold becoming rough. Hence, nickel group alloy molds are not suitable for molding glass optical elements with high accuracy.

Various composite molds for press molding optical lenses have been developed to solve the above-described problems. One typical kind of composite mold comprises a base material, and a press surface film formed on the base material. The press surface film is an Ir film, or a Ru film, or an alloy film comprising Ir and at least one material selected from the group consisting of Pt, Re, Os, Rh and Ru, or an alloy film comprising Ru and at least one material selected from the group consisting of Pt, Re, Os and Rh. Another kind of composite mold includes a base portion and a surface film formed on the base portion. The base portion is a high hardness alloy or metal ceramic. The surface film is diamond like carbon. However, the working lifetime of these kinds of composite molds is limited. This is because when the mold is manufactured, the finished surface film typically has internal stresses the surface film can easily peel off, or generate In use of the mold, micro cracks may be generated in the surface film due to the action of the the innerternal stresses. Therefore the surface film may easily peel off after repeated use of the mold.

What is needed, therefore, is a mold for press molding optical lenses, in which the mold has high mechanical strength and does not deform at high temperatures. In addition, the mold should be easily patternable in order to form lenses having a desired configuration, and should be resistant to micro cracking after a period of time of usage.

### SUMMARY

In one embodiment, a mold for molding an optical lenses includes a press molding part having a press surface. A material of the press molding part is a composition of cerium partially stabilized zirconia (Ce—PSZ), yttrium partially stabilized zirconia (Y—PSZ), alumina (Al₂O₃), and one or more noble metals. The noble materietals are selected from the group consisting of platinum (Pt), platinum-iridium alloy (PtIr), and rhenium-iridium alloy (ReIr). A shape of the press surface is spherical or aspheric.

In another embodiment, the mold for molding an optical lenses further includes a molding base adjoining the press molding part. Preferably, the a material of the molding base material is selected from the group consisting of hard alloy, ceramic, and a silicon-based substrate. The press molding part is formed together withon the molding base together by a hot pressing method.

In the still another embodiment, the mold for molding an optical lenses further includes an intermediate layer. The intermediate layer is placed between the press molding part and the molding base. Preferably, the a material of the intermediate layer is tungsten or tantalum. The intermediate layer is formed on the molding base by a sputtering deposition method. The A thickness of the intermediate layer is less than 1 micrometer.

Compared withUnlike in the prior arts, the present inventionabove-described embodiments ustilize a composition of Ce—PSZ, Y—PSZ, Al₂O₃, and one or more noble metals as raw a materials of a mold for press molding an optical lens. Because tThe properties of Ce—PSZ, Y—PSZ, and Al₂O₃ these composition are complementary. Therefore the mold for molding an optical lens has a number of advantages, such as high mechanical strength, does notresistance to deformation at high temperatures, angood release ability of a formed drawing the lens frorm the press surfacemold, etc.

Other advantages and novel features will become more apparent from the following detailed description of preferred embodiments when taken in conjunction with the accompanying drawings.

### BRIEF DESCRIPTION OF THE DRAWINGS

Many aspects of the present invention can be better understood with reference to the following drawings. The components in the drawings are not necessarily to scale, the emphasis instead being placed upon clearly illustrating the principles of the present mold for press molding optical lenses.

FIG. 1 is a schematic, side cross-sectional view of a mold for press molding optical lenses in accordance with a first preferred embodiment of the present invention.

FIG. 2 is a schematic, side cross-sectional view of a mold for press molding optical lenses in accordance with a second preferred embodiment of the present invention.

FIG. 3 is a schematic, side cross-sectional view of a mold for press molding optical lenses in accordance with a third preferred embodiment of the present invention.

Corresponding reference characters indicate corresponding parts throughout the several views. The exemplifications set out herein illustrate preferred embodiments of the present invention, and such exemplifications are not to be construed as limiting the scope of the invention in any manner.

### DETAILED DESCRIPTION OF PREFERRED EMBODIMENTS

Reference will now be made to the drawings to describe embodiments of the present invention, in detail.

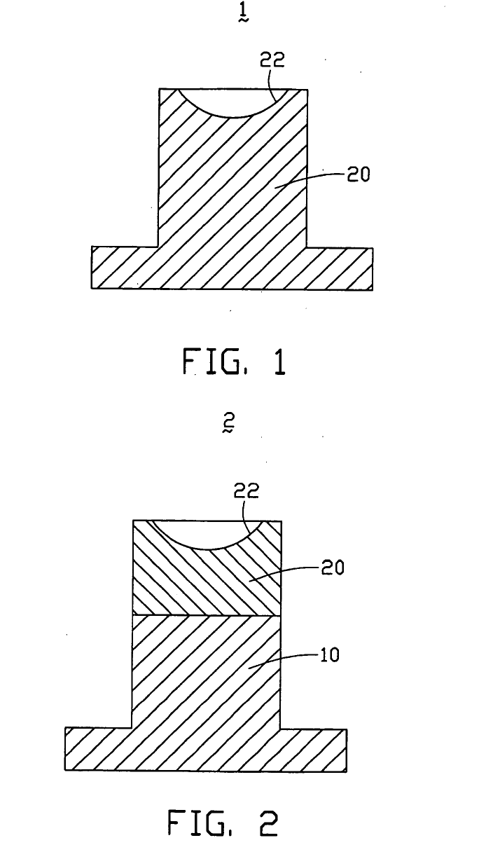

FIG. 1 shows a mold 1 for press molding optical lenses in accordance with a first embodiment of the present invention. The mold 1 comprises a press molding part 20, which has a press surface 22. A material of the press molding part 20 is a composition of cerium partially stabilized zirconia (Ce—PSZ), yttrium partially stabilized zirconia (Y—PSZ), alumina (Al₂O₃) and noble metals, all of which are homogeneously distributed throughout the material. Preferably, the noble metals are Platinum (Pt), Platinum-Iridium alloy (PtIr), and Rhenium-Iridium alloy (ReIr). A shape of the press surface 22 is spherical or aspheric, and is determined according to a desired shape of an optical lens formed by using the mold 1. In addition, an optical pattern can be carved on the press surface 22.

A process of manufacturing the mold 1 is as follows: first, mixing Ce—PSZ, Y—PSZ, Al₂O₃ and noble metals particles thoroughly; putting the mixture of particles in a press mold (not shown); pressing and sintering the mixture of particles by a hot pressing method to form a precursor of the mold 1; and finally, cutting the spherical or aspheric press surface 22 on the precursor mold 1 by using precision cutting tools, thereby obtaining the mold 1. In addition, an optical pattern (not shown) can be carved on the press surface 22 by using diamond carving tools.

FIG. 2 shows a mold 2 for press molding optical lenses in accordance with a second embodiment of the present invention. The mold 2 comprises a press molding part 20 and a molding base 10. A material of the press molding part 20 is a composition of cerium partially stabilized zirconia (Ce—PSZ), yttrium partially stabilized zirconia (Y—PSZ), alumina (Al₂O₃), and noble metals. Preferably, the noble metals are platinum (Pt), platinum-iridium alloy (PtIr), and rhenium-iridium alloy (ReIr). A shape of the press surface 22 is spherical or aspheric, and is determined according to a desired shape of an optical lens formed by using the mold 2. In addition, an optical pattern can be carved on the press surface 22. The press molding part 20 is formed on the molding base 10. The molding base 10 is made of a sintered hard alloy mainly comprising tungsten carbide (WC), or cermet mainly comprising TiC, TiN, Cr₃C₂ or Al₂O₃, or is a silicon-based substrate. All of these materials have good heat-resistance, superior workability, and good adhesive properties.

A process of manufacturing the mold 2 is as follows: (1) putting a material of hard alloy, ceramic or silicon in the a bottom of a press mold (not shown); (2) mixing Ce—PSZ, Y—PSZ, Al₂O₃ and noble metals particles thoroughly, and putting the mixture in the press mold; (3) pressing and sintering all the above materials by a hot pressing method to form a precursor of the mold 2; and (4) cutting the spherical or aspheric press surface 22 on the press molding part 20 by using precision cutting tools, thereby obtaining the mold 2. In addition, an optical pattern (not shown) can be carved on the press surface 22 by using diamond carving tools.

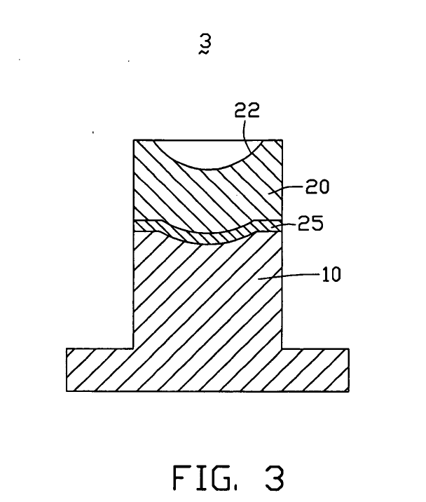

FIG. 3 shows a mold 3 for press molding optical lenses in accordance with a third embodiment of the present invention. The mold 3 comprises a press molding part 20, a molding base 10, and an intermediate layer 25. A material of the press molding part 20 is a composition of cerium partially stabilized zirconia (Ce—PSZ), yttrium partially stabilized zirconia (Y—PSZ), alumina (Al₂O₃), and noble metals. Preferably, the noble metals are platinum (Pt), platinum-iridium alloy (PtIr), and rhenium-iridium alloy (ReIr). A shape of the press surface 22 is spherical or aspheric, and is determined according to a desired shape of an optical lens formed by using the mold 3. In addition, an optical pattern can be carved on the press surface 22. The press molding part 20 is formed on the molding base 10. The molding base 10 is made of a sintered hard alloy mainly comprising tungsten carbide (WC), or cermet mainly comprising TiC, TiN, Cr₃C₂ or Al₂O₃, or is a silicon-based substrate. All of these materials have good heat-resistance, superior workability, and good adhesive properties. The intermediate layer 25 is sandwiched between the press molding part 20 and the molding base 10, for enhancing the strength of connectivity of the press molding part 20 with the molding base 10. Preferably, a material of the intermediate layer 25 is tungsten or tantalum. A thickness of the intermediate layer 25 is less than 1 micrometer.

A processes of manufacturing the mold 3 is as follows: (1) press molding and sintering a material of hard alloy, ceramic or silicon to form the molding base 10; (2) forming the intermediate layer 25 on the molding base 10 by a sputtering deposition method; (3) putting the combined molding base 10 and intermediate layer 25 into a press mold (not shown), mixing Ce—PSZ, Y—PSZ, Al₂O₃ and noble metals particles thoroughly, and putting the mixture on the intermediate layer 25; (4) pressing and sintering all the above materials by a hot pressing method to form a precursor of the mold 3; and (5) cutting the spherical or aspheric press surface 22 on the press molding part 20 by using precision cutting tools, thereby obtaining the mold 3. In addition, an optical pattern can be carved on the press surface 22 by using diamond carving tools.

In the above-described embodiments, the phenomenon of phase transformation of Zzirconia is utilized in the development of a tough grade of mold material. The increased toughness is due to the stress-induced transformation of zZirconia particles in the vicinity of each of propagation cracks by absorbing the energy at the crack front and due to the volume change from phase transformation. Cerium and yYttrium are two materials often used in PSZ (Ppartially Sstabilized Zzirconia). Ce—PSZ has very good resistance to transformation in the range 200° C.˜3000° C. during annealing, but has low hardness. Y—PSZ has high hardness, but loses strength in the range 200° C.˜3000° C. during annealing. Al₂O₃ has good hardness at high temperatures. Unlike in the prior art, the present invention utilizes Ce—PSZ, Y—PSZ, Al₂O₃ and noble metals mixed together thoroughly to be the raw material for a mold. The finished mold has high mechanical strength, and resists deformation at high temperatures. In addition, the noble metals such as Pt, PtIr and ReIr have good heat-resistance, superior workability, and good adhesive properties. Therefore patterns can be readily drawn in the press surface of the mold in order to obtain an optical lens having a desired configuration.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A mold for molding an optical lenses, the mold comprising a press molding part having a press surface, wherein a material of the press molding part is a composition of cerium partially stabilized zirconia (Ce—PSZ), yttrium partially stabilized zirconia (Y—PSZ), alumina (Al₂O₃), and one or more noble metals.

2. The mold as claimed in claim 1, wherein a shape of the press surface is spherical.

3. The mold as claimed in claim 1, wherein a shape of the press surface is aspheric.

4. The mold as claimed in claim 1, wherein the noble metals are selected from the group consisting of platinum (Pt), platinum-iridium alloy (PtIr), and rhenium-iridium alloy (ReIr).

5. The mold as claimed in claim 1, wherein the Ce—PSZ, Y—PSZ, Al₂O₃ and noble metals are homogeneously distributed in the composition.

6. The mold as claimed in claim 1, further comprising a molding base adjoining the press molding part.

7. The mold as claimed in claim 6, wherein a material of the molding base is a hard alloy.

8. The mold as claimed in claim 6, wherein a material of the molding base is ceramic.

9. The mold as claimed in claim 6, wherein the molding base is a silicon-based substrate.

10. The mold as claimed in claim 6, wherein the molding base and the press molding part are formed together by a hot pressing method.

11. The mold as claimed in claim 6, further comprising an intermediate layer sandwiched between the press molding part and the molding base.

12. The mold as claimed in claim 11, wherein a material of the intermediate layer is tungsten.

13. The mold as claimed in claim 11, wherein a material of the intermediate layer is tantalum.

14. The mold as claimed in claim 11, wherein the intermediate layer is formed on the molding base by a sputtering deposition method.

15. The mold as claimed in claim 11, wherein a thickness of the intermediate layer is less than 1 micrometer.

16. The mold as claimed in claim 11, wherein the press molding part, the intermediate layer and the molding base are formed together by a hot pressing method.

17. The mold as claimed in claim 1, further comprising an optical pattern carved on the press surface.
